(19) United States
(12) Patent Application Publication
(10) Pub. No.: US 2010/0169678 A1
(43) Pub. Date: Jul. 1, 2010

(54) DATA STORAGE DEVICE, METHOD FOR CONTROLLING THE SAME, AND RECORDING MEDIUM

(75) Inventor: Yasuhiro Kozuka, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/643,483

(22) Filed: Dec. 21, 2009

(30) Foreign Application Priority Data
Dec. 27, 2008 (JP) 2008-335391

(51) Int. Cl. G06F 1/32

(52) U.S. Cl. 713/310; 713/323

(57) ABSTRACT

A data storage device transmits, when shifting to a power-saving condition, identification information (file name, and pass information) of data to another data storage device of a standby condition present in a network, in order to shift to the power-saving condition. When there is no other data storage in the standby condition in the network, the control unit specifies on of the other data storage devices an amount of power consumption of which is lower than that of the data storage device, and transmits the identification information to specified data storage device in the standby condition.

### BACKGROUND OF THE INVENTION

1. Field of the Invention

The present invention relates to a data storage device, a method for controlling the same, and a recording medium.

2. Description of the Related Art

Recently, a storage device such as a hard disk has been mounted on a digital multifunction peripheral to be used as a temporary storage box for image data to be processed. A part of a storage area of the storage box is open to a user, whereby the user can store data therein.

Especially, the digital multifunction peripheral has a file sharing function which enables other devices connected via a network to access, browse and output electronic data stored in each storage device.

In the case of using the file sharing function, the devices keep the conditions which allow each other to access internal information. In other words, in the conventional technology each device is to operate in a mode not to enter a sleep condition independently. Each device is to be kept woken up.

However, if all the devices corresponding to the storage boxes and connected to the network are kept woken up, power is unnecessarily wasted.

Japanese Patent Application Laid-Open No. 2005-205830 offers, as a method for optimizing a power saving environment of a plurality of printers connected via a network, a system which enables a shift to a power saving mode (sleep condition) based on sleep level information (use frequency/time correlation information), or automatic waking-up from the power saving mode.

In the method discussed in Japanese Patent Application Laid-Open No. 2005-205830, however, when even one digital multifunction peripheral which provides storage areas is powered off, the system cannot respond to a request of access to a file. In consequence, a file sharing function cannot be established.

The following method is conceivable as a solution to the above-mentioned situation. When each device shifts to a sleep condition, the device shifts to the sleep condition after it transmits only certain information (e.g., a file name) of a file therein to the other device. When a request of access to the file is received, the entrusted device responds by proxy.

In this method, however, when the digital multifunction peripherals that use the file sharing function shift to sleep conditions one after another to leave only a last one, the device is inhibited to shift to asleep condition. In such a condition, if standby power consumption of the last remaining device is large, the system uselessly consumes power.

Thus, the system that includes the data storage devices having the file sharing function to enable the data storage devices connected via the network to refer to mutual data has had a difficulty of suppressing power consumption while maintaining the file sharing function.

### SUMMARY OF THE INVENTION

According to an aspect of the present invention, a data storage device includes a first storage unit configured to store data, a reception unit configured to receive a request of access to the stored data from an external device, a transmission unit configured to transmit, to the external device, data corresponding to the access request, a control unit configured to perform, when shifting from a standby condition to a power saving condition, control so that identification information for identifying the stored data is transmitted to other data storage devices in the standby condition. In this case, when there are no other data storage devices in the standby condition, the control unit specifies one of the other data storage devices, an amount of power consumption of which is lower than that of the data storage device by referring to the stored standby power information, causes the specified data storage device to shift from the power saving condition to the standby condition and transmits the identification information to the specified data storage device in the standby condition.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a system configuration diagram illustrating an example of a configuration of a system including digital multifunction peripherals to which digital storage devices can be applied according to a first exemplary embodiment of the present invention.

FIG. 2 is a block diagram illustrating a schematic internal configuration of each of the digital multifunction peripherals illustrated in FIG. 1.

FIG. 3 illustrates an example of a data file stored in a shared file storage unit illustrated in FIG. 2 by lists of names and network pass information.

FIGS. 4A to 4C are conceptual diagrams each illustrating a condition of a shared file stored in the shared file storage unit of each digital multifunction peripheral.

FIG. 5 is a flowchart illustrating processing when the digital multifunction peripheral of the exemplary embodiments enters a sleep condition.

FIG. 6 illustrates an example of a power management table stored in a data storage unit.

FIG. 7 is a flowchart illustrating an example of a power management table generation method according to the exemplary embodiment.

FIG. 8 illustrates an example of a power management table stored in the data storage unit when the digital multifunction peripheral is connected to a network for the first time.

FIGS. 9A and 9B are flowcharts illustrating processing when a device on standby receives file information from a device which shifts to a sleep condition.

FIG. 10 illustrates an example of a display screen of an operation panel displaying a stored condition of data in a shared BOX.

FIG. 11 illustrates an operation when a file name “AA2” stored in a device A in a sleep condition is selected from files on the display screen of FIG. 10.

FIG. 12 illustrates a screen of the operation panel when “YES” on the screen of FIG. 11 is pressed to wake up the device A from the sleep condition.

FIG. 13 is a system configuration diagram illustrating an example of a configuration of a system including digital multifunction peripherals to which data storage devices can be applied according to a second exemplary embodiment of the present invention.

FIG. 14 illustrates an example of an operation screen when a shared BOX folder is opened by a file sharing function from a PC illustrated in FIG. 13.

FIG. 15 illustrates an example of a selection screen displayed on the PC when a device B is selected.

FIG. 16 is a conceptual diagram illustrating stored data which each multifunction peripheral stores in a shared BOX folder according to a third exemplary embodiment of the present invention.

FIG. 17 illustrates a condition where as a result of transmitting and receiving file information in shared BOX folders among devices from a condition of FIG. 16, each device stores a part of file information of the other device in its shared BOX folder.

FIG. 18 illustrates a condition where devices A, C and D enter sleep conditions from the condition of FIG. 17, and hence only a device B stores all file information on behalf of the other devices.

FIG. 19 is a flowchart illustrating an example of processing when the digital multifunction peripheral of the exemplary embodiment transmits file information to the other devices connected via a network at the time of waking-up.

FIG. 20 is a flowchart illustrating processing when the digital multifunction peripheral of the exemplary embodiment enters a sleep condition.

### DESCRIPTION OF THE EMBODIMENTS

Various exemplary embodiments, features, and aspects of the invention will be described in detail below with reference to the drawings.

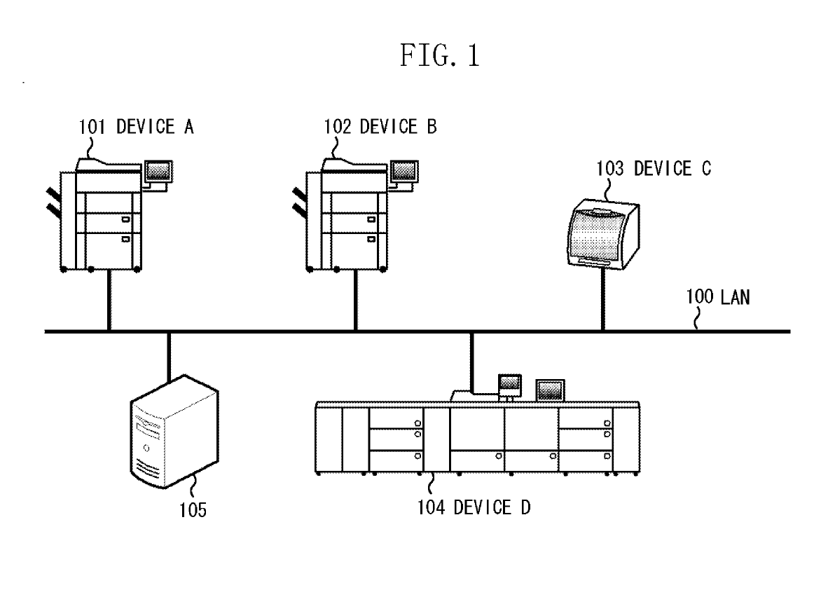

FIG. 1 is a system configuration diagram illustrating an example of a configuration of a system including digital multifunction peripherals to which data storage devices can be applied according to a first exemplary embodiment of the present invention.

In FIG. 1, digital multifunction peripherals 101, 102, 103 and 104 functioning as data storage devices are connectable to a network 100 such as a LAN, and have file sharing functions of sharing files via the network 100. A PC server 105 is connected to the network 100. The digital multifunction peripherals 101 to 104 and the PC server 105 are interconnected via the network 100.

The number of devices connected to the network is not limited to that in the configuration of FIG. 1. Nor types of devices connected to the network are limited to the digital multifunction peripherals or the PC server. The file sharing function is a function of receiving a request of access to data stored therein from an external device connected to the network, and transmitting, upon reception of the access request, data corresponding to the access request to the external device.

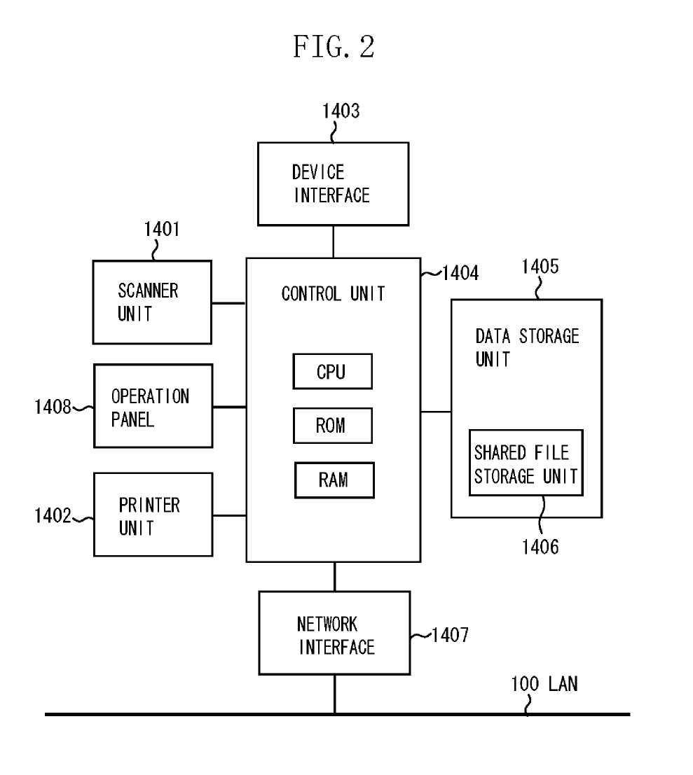

FIG. 2 is a block diagram illustrating a schematic internal configuration of each of the digital multifunction peripherals 101 to 104 illustrated in FIG. 1.

As illustrated in FIG. 2, each of the digital multifunction peripherals 101 to 104 includes a control unit 1404, a scanner unit 1401, a printer unit 1402, a device interface 1403, a network interface 1407, an operation panel 1408, and a data storage unit 1405.

The control unit 1404 includes a CPU, a ROM, a RAM and the like, and reads and executes a program stored in the ROM with the CPU to perform overall control of the digital multifunction peripheral. The RAM is used as a work area of the CPU. The ROM stores, in addition to the program executed by the CPU, various types of data including information indicating standby power consumption of its own device.

The device interface 1403 is an interface to the other devices. The network interface 1407 is provided to send and receive information to and from the other devices via the network 100. The operation panel 1408 is provided to set or operate the digital multifunction peripheral.

The data storage unit 1405 includes a shared file storage unit 1406 which can share and use a part of the data storage unit 1405 with the external device. The control unit 1404 controls a data file such as image data stored in the shared file storage unit 1406 so as to permit the other devices to access the data file via the network 100. In other words, the control unit 1404 receives requests of access to data stored in the shared file storage unit 1406 of its own device from the other devices connected to the network 100, and performs, upon reception of the access requests, control to transmit data corresponding to the access requests to the other devices. This control enables the digital multifunction peripherals 101 to 104 to realize file sharing functions.

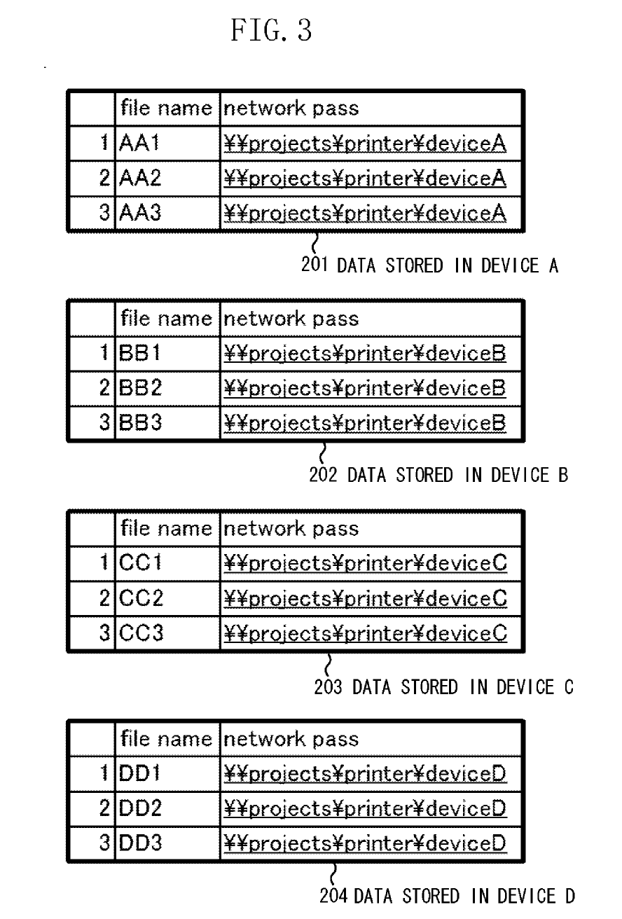

FIG. 3 illustrates an example of a data file stored in the shared file storage unit 1406 illustrated in FIG. 2 by lists of names and network pass information.

In the exemplary embodiment, the data file stored in the shared file storage unit 1406 contains a file name and pass information (network pass) of the network storing the data file as supplementary information. As illustrated in FIG. 3, the shared file storage unit 1406 of the exemplary embodiment manages the data file stored in the shared file storage unit 1406 by using the file name and the pass information. The control unit 1404 displays the file name and the pass information (file information described below) on the external device or the operation panel 1408 to receive access to the data file stored in the shared file storage unit 1406.

In FIG. 3, data 201 indicates examples of data files stored in a device A (101) by lists of names and pass information. In other words, the shared file storage unit 1406 of the device A (101) stores data files of file names “AA1”, “AA2” and “AA3”.

Data 202, 203, and 204 respectively indicate examples of data files stored in devices B (102), C (103) and D (104). In other words, the shared file storage unit 1406 of the device B (102) stores files of file names “BB1”, “BB2”, and “BB3”. The shared file storage unit 1406 of the device C (103) stores files of file names “CC1”, “CC2”, and “CC3”. The shared file storage unit 1406 of the device D (104) stores files of filenames “DD1”, “DD2”, and “DD3”.

A data management format of data files is not limited to the above format. For pass information, any other information such as an IP address may be used as long as a location of a device storing data files can be specified.

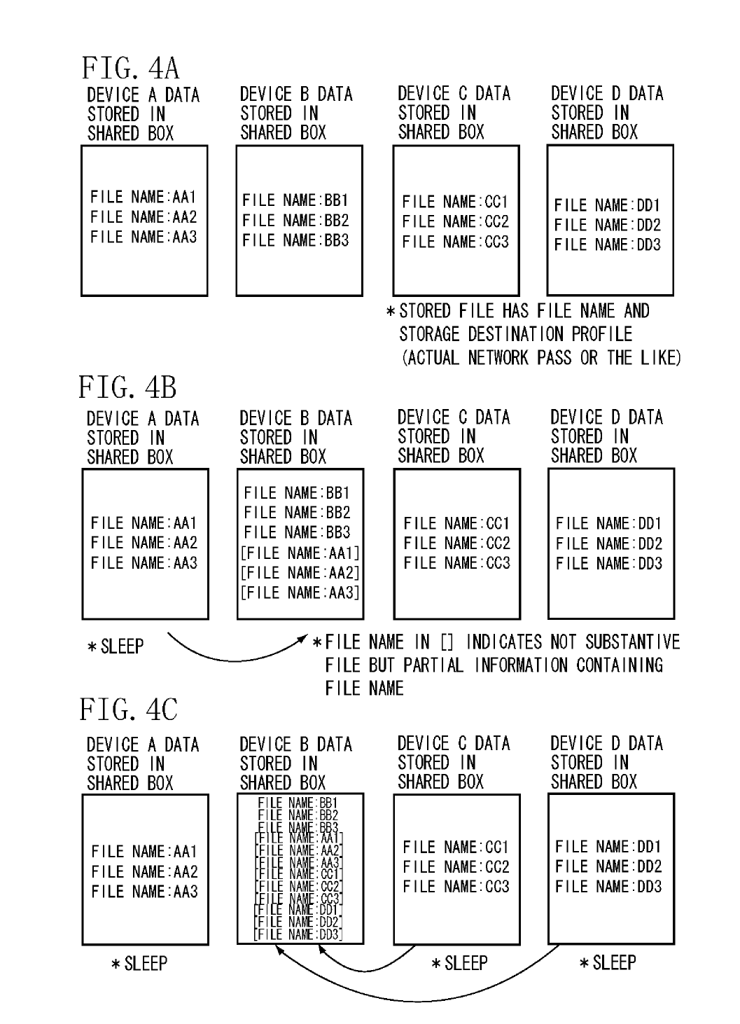

FIGS. 4A to 4C are conceptual diagrams each illustrating a condition of a shared file (data file) stored in the shared file storage unit 1406 of each digital multifunction peripheral.

FIG. 4A conceptually illustrates a condition of a shared file stored in each device in a status where each digital multifunction peripheral has woken up.

FIG. 4B illustrates data transfer when the device A (101) shifts from the condition of FIG. 4A to a sleep condition.

In the exemplary embodiment, during shifting of the device A (101) to the sleep condition, the device A (101) transmits not a substantive file but identification information enabling specifying of a file such as a file name or pass information of the network to the device B (102). Hereinafter, the identification information is referred to as “partial information” or “file information”. The above transmission processing enables, even if the device A (101) is set in a sleep condition, the device B (102) to display file information of a file stored in the device A (101) by proxy. Further, based on this file information, the device B (102) can receive access to the file stored in the device A (101). The file information may contain other information such as information of a date and time when a file was created, information of a file creator, a file size, a number of pages, and a thumbnail image.

FIG. 4C illustrates a condition where only the device B (102) can display file information of all files on behalf of the other devices while the devices C (103) and D (104) have both shifted to sleep conditions. In this case, based on file information transmitted from the devices C (103) and D (104), the device B (102) can receive access to the files stored in the devices A (101), C (103), and D (104) by proxy.

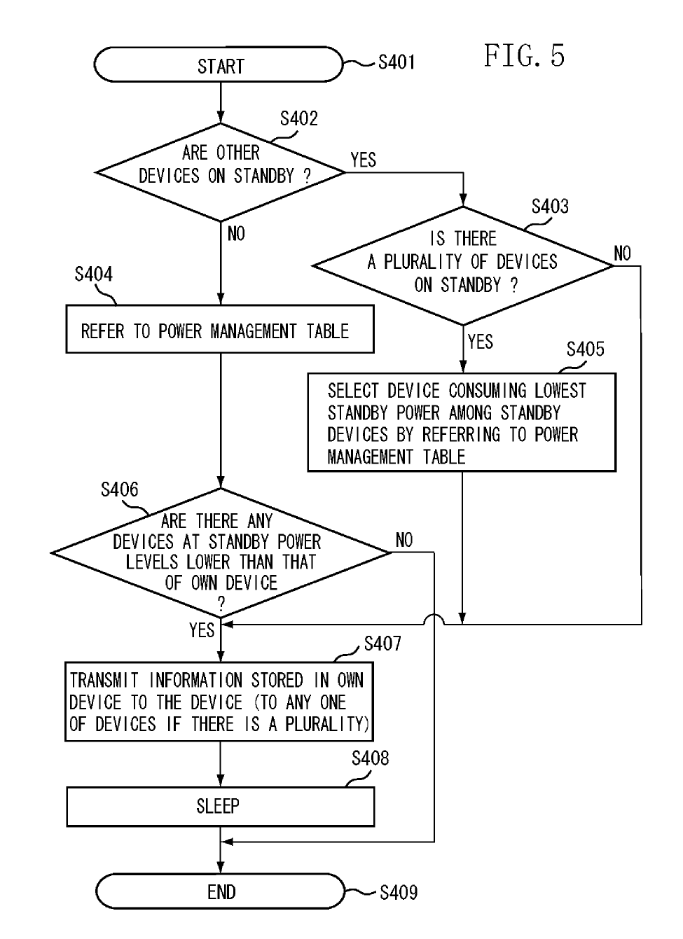

Referring to FIG. 5, processing when the digital multifunction peripheral of the present invention enters a sleep condition will be described.

FIG. 5 is a flowchart illustrating processing when the digital multifunction peripheral of the exemplary embodiment enters a sleep condition. The processing of the flowchart is realized in a manner that the CPU of the control unit 1404 reads the program stored in the ROM of the control unit 1404 to execute it.

First, in step S401, the CPU of the control unit 1404 executes monitoring to determine whether sleep conditions have been satisfied. Upon determining that the sleep conditions have been satisfied, the CPU of the control unit 1404 starts the processing of the flowchart.

In step S402, the CPU of the control unit 1404 determines whether other devices connected within the same network are on standby. If it is determined that the other devices are on standby (YES in step S402), the CPU of the control unit 1404 proceeds to step S403.

In step S403, the CPU of the control unit 1404 determines whether there is a plurality of devices on standby. If it is determined that there is a plurality of devices on standby (YES in step S403), the CPU of the control unit 1404 proceeds to step S405.

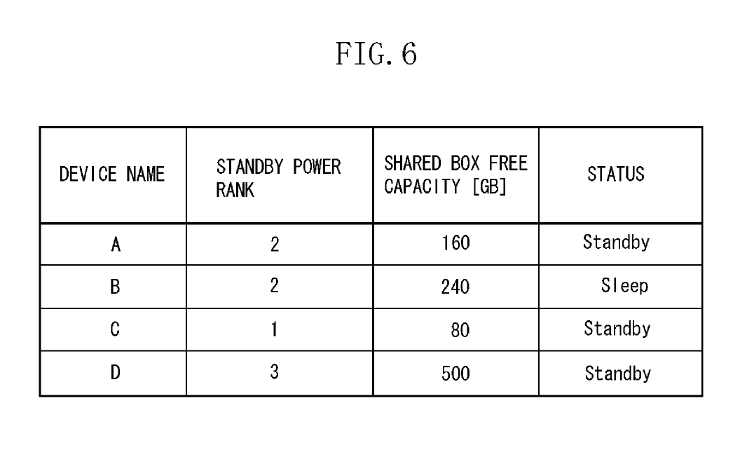

Instep S405, the CPU of the control unit 1404 selects a device consuming lowest standby power among the standby devices by referring to a power management table of FIG. 6 stored in the data storage unit 1405. Then, the CPU of the control unit 1404 proceeds to step S407.

On the other hand, if it is determined that there is only one device on standby (NO in step S403), the CPU of the control unit 1404 selects the device to proceed to step S407.

If it is determined that no other devices are on standby, in other words, there is only one device having a file sharing function, i.e., an own device, in the same network group (NO in step S402), the CPU of the controlling unit 1404 proceeds to step S404.

In step S404, the CPU of the control unit 1404 refers to the power management table of FIG. 6 stored in the data storage unit 1405 to proceed to step S406.

In step S406, based on the power management table of FIG. 6, the CPU of the control unit 1404 determines whether there are any devices in sleep conditions at standby power consumption levels lower than that of the own device. If it is determined that there are devices in sleep conditions at standby power consumption levels lower than that of the own device (YES in step S406), the CPU of the control unit 1404 selects the devices to proceed to step S407.

In step S407, the CPU of the control unit 1404 transmits information stored in the own device to the selected devices. If it is determined in step S406 that there is a plurality of devices in sleep conditions at standby power consumption levels lower than that of the own device, the CPU of the control unit 1404 determines which of the devices at the standby power consumption levels lower than that of the own device is to wake up according to a predetermined determination order. For example, the CPU of the control unit 1404 makes determination based on a priority, for example, according to a high usage frequency or a large free capacity of the shared file storage units 1406. If it is determined in step S405 that there is a plurality of devices consuming lowest standby power among activated ones, the CPU of the control unit 1404 determines which of the devices is to wake up according to a predetermined determination order.

Next, in step S408, the CPU of the control unit 1404 shifts to a sleep condition and, in step S409, finishes the processing of the flowchart.

On the other hand, if it is determined that there is no device in a sleep condition at a standby power consumption level lower than that of the own device (NO in step S406), in step S409, the CPU of the control unit 1404 finishes the processing of the flowchart without shifting to a sleep condition.

In the exemplary embodiment, in step S405, the CPU of the control unit 1404 determines devices to which file information is transmitted in an order of standby power consumption starting from the smallest one in the power management table. However, a method for determining a file information transmission destination is not limited to this method. For example, a configuration may be employed that determines devices to which data information is transmitted based on other criteria preset and managed in the power management table such as access frequencies and free capacities of the shared file storage units 1406.

FIG. 6 illustrates an example of a power management table stored in the data storage unit 1405.

As illustrated in FIG. 6, the power management table includes standby power consumption ranks of the devices A to D, free capacities of the shared file storage units 1406, status information, and other information (not illustrated).

The standby power consumption rank indicates ranking of standby power values of the devices in order of “1”, “2”, and “3” within a certain range. In the exemplary embodiment, the standby power consumption rank defines standby power values in order of 1<2<3.

The status information indicates which of a standby condition and a sleep condition the device is in. Further, the shared BOX free capacity indicates a free capacity of the shared file storage unit 1406 (hereinafter, referred to as “shared BOX folder”).

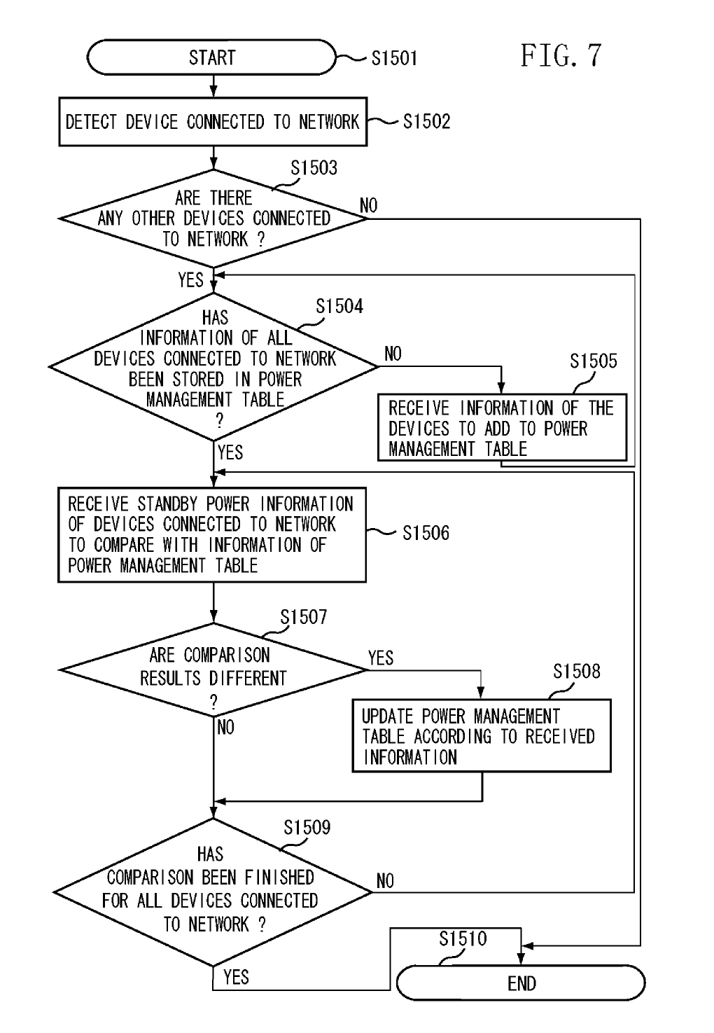

Referring to FIG. 7, the method for generating a power management table illustrated in FIG. 6 will be described below.

FIG. 7 is a flowchart illustrating an example of the method for generating a power management table according to the exemplary embodiment. Processing of the flowchart is realized when the CPU of the control unit 1404 reads a program stored in the ROM of the control unit 1404 to execute the program.

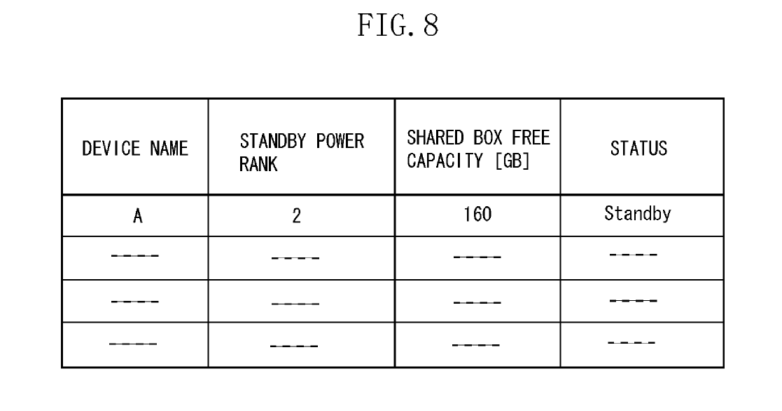

Each device having a file sharing function and connected to the network includes a power management table in its data storage unit 1405. When connected to the network for the first time, as illustrated in FIG. 8, the device includes only a management table of its own beforehand.

FIG. 8 illustrates an example of a power management table stored in the data storage unit 1405 when the digital multifunction peripheral is connected to the network for the first time.

Each step of FIG. 7 will be described below.

In step S1501, when the digital multifunction peripheral wakes up, and its connection to the network is detected, the CPU of the control unit 1405 starts the processing of the flowchart.

In step S1502, the CPU of the control unit 1404 detects other devices connected to the network. In step S1503, based on a result of the detection, the CPU of the control unit 1404 determines whether there are any other devices connected to the network.

If it is determined that there are no other devices connected to the network (NO in step S1503), in step S1510, the CPU of the control unit 1404 finishes the processing of the flowchart.

On the other hand, if it is determined that there are other devices connected to the network (YES in step S1503), the CPU of the control unit 1404 proceeds to step S1504.

In step S1504, the CPU of the control unit 1404 determines whether information of all the other devices connected to the network has been stored in the power management table. If it is determined that there is information of other devices connected to the network yet to be stored in the power management table (NO in step S1504), the CPU of the control unit 1404 proceeds to step S1505.

In step S1505, the CPU of the control unit 1404 communicates with any of the other devices (hereinafter, relevant devices) whose information is yet to be stored in the power management table, and receives the information from the relevant devices to add it to the power management table. Then, returning to step S1504, the CPU of the control unit 1404 repeats steps S1504 and S1505 until the information of all the other devices connected to the network is stored in the power management table.

If it is determined that the information of all the other devices connected to the network has been stored in the power management table (YES in step S1504), the CPU of the control unit 1404 proceeds to step S1506.

In step S1506, the CPU of the control unit 1404 communicates (makes a request to) with any of the other devices (hereinafter, relevant devices) registered in the power management table to receive information (including standby power information) of the devices transmitted from the relevant devices. Then, the CPU of the control unit 1404 compares the received standby power information of the relevant devices with that of the relevant devices registered in the power management table to proceed to step S1507.

In step S1507, based on a result of the comparison of step S1506, the CPU of the control unit 1404 determines whether the received standby power information of the relevant devices is different from that of the relevant devices registered in the power management table.

If it is determined that the received standby power is different from that of the relevant devices registered in the power management table (YES in step S1507), the CPU of the control unit 1404 determines that a device configuration has been changed and proceeds to step S1508.

In step S1508, the CPU of the control unit 1404 updates the power management table according to the received information of the relevant devices and proceeds to step s1509.

On the other hand, if it is determined that the received standby power information is similar to that of the relevant devices registered in the power management table (NO in step S1507), the CPU of the control unit 1404 directly proceeds to step S1509.

In step S1509, the CPU of the control unit 1404 determines whether the processing of steps S1506 to S1508 has been finished for all the other devices connected to the network. If it is determined that the processing is yet to be finished (NO in step S1509), the CPU of the control unit 1404 returns to step S1506.

On the other hand, if it is determined that the processing of steps S1506 to S1508 has been finished for all the other devices connected to the network (YES in step S1509), in step S1510, the CPU of the control unit 1404 finishes the processing of the flowchart. The method for obtaining power management table information is not limited to the method illustrated in FIG. 7. For example, power management tables held by the other devices may be directly received from the other devices.

Before finishing the flowchart, the CPU of the control unit 1404 may transmit standby power information of its own device to all the devices which have woken up.

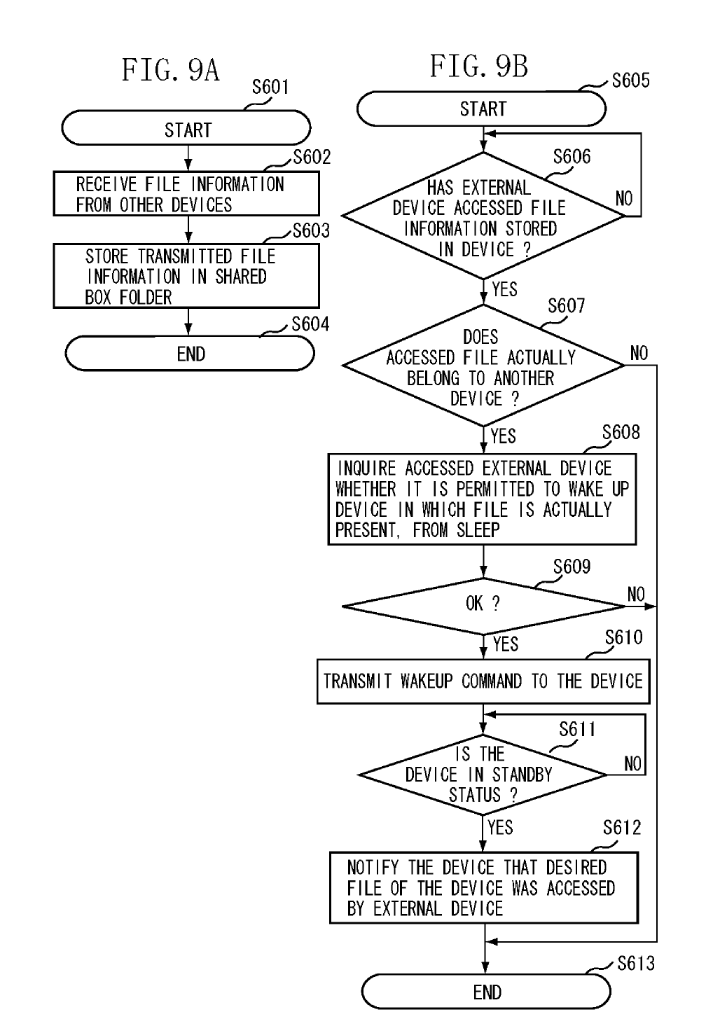

FIGS. 9A and 9B illustrate processing when a device on standby receives file information from a device which shifts to a sleep condition and its subsequent processing will be described below.

FIGS. 9A and 9B are flowcharts illustrating processing when the device on standby receives file information from the device which shifts to a sleep condition. Specifically, FIG. 9A illustrates processing when the device on standby receives file information from the device which shifts to a sleep condition. FIG. 9B illustrates processing when an external device accesses file information stored in the device.

In step S601, upon detecting transmission of file information from the other devices to the own device via the network (e.g., transmission of step S407 of FIG. 5), the CPU of the control unit 1404 starts the processing of FIG. 9A.

In step S602, the CPU of the control unit 1404 receives file information (e.g., file information transmitted in step S407 of FIG. 5) transmitted from the other devices (i.e., devices which shift to sleep conditions).

Next, in step S603, the CPU of the control unit 1404 stores the file information received in step S602 in the shared BOX folder. In step S604, the CPU of the control unit 1404 finishes the processing of FIG. 9A. Based on this file information, even if the other devices enter the sleep conditions, the CPU of the control unit 1404 can display file information of files stored in the other devices by proxy. Further, based on the file information, the CPU of the control unit 1404 can receive access to the files stored in the other devices by proxy.

In step S605, after waking-up of the device, the CPU of the control unit 1404 starts the processing of FIG. 9B.

In step S606, the CPU of the control unit 1404 determines whether an external device has accessed file information stored in the shared BOX folder in the own device. If it is determined that the external device has accessed the file information (YES in step S606), the CPU of the control unit 1404 proceeds to step S607. As described above, the control unit 1404 displays file information of the data file stored in the own device and file information received from the other devices (file information not substantive in the own device) on the external device or the like, and receives access to the data file. Thus, the accessed file information may be not only file information of the substantive data file in the own device but also file information of substantive data files in the other devices.

Next, in step S607, the CPU of the control unit 1404 determines whether the file information access-detected in step S605 belongs to another device (whether the file information has been received and stored in FIG. 9A, its accessing having being received on behalf of other devices).

If it is determined that the access-detected substantive file information belongs to another device (YES in step S607), the CPU of the control unit 1404 proceeds to step S608.

In step S608, the CPU of the control unit 1404 inquires the accessed external device (access source) whether it is permitted to wake up the device in which a file is actually present, from a sleep condition.

In step S609, the CPU of the control unit 1404 stands by for a reply (response) from the accessed external device, and determines whether there has been an OK response (response indicating that it is permitted to wake up the device from sleep) from the accessed external device.

If it is determined that there has been no OK response (response indicating that it is permitted to wake up the device from sleep) from the accessed external device (NO in step S609), in step S613, the CPU of the control unit 1404 finishes the processing of FIG. 9B. In other words, the CPU of the control unit 1404 finishes the processing when there is an NG response (response indicating that it is not permitted to wake up the device from sleep), or when there is no reply (response) from the accessed external device within a predetermined time period.

On the other hand, if it is determined that there has been an OK response (response indicating that it is permitted to wake up the device from sleep) from the accessed external device (YES in step S609), the CPU of the control unit 1404 proceeds to step S610.

In step S610, the CPU of the control unit 1404 transmits a wake-up command to the device (the other device above described) which stores the accessed substantive file (other device wake-up processing). The digital multifunction peripheral that has received the wake-up command returns to the standby condition (woken-up condition) from the sleep condition.

Then, in step S611, the CPU of the control unit 1404 stands by until the device which stores the accessed substantive file is set in a standby condition. After the device has been set in the standby condition, the CPU of the control unit 1404 notifies the device that the external device has accessed the file stored in the device (information about the file is also notified). Then, in step S613, the CPU of the control unit 1404 finishes the processing of FIG. 9B.

In the present flowchart, there is access from the external device. However, similar processing is carried out when there is direct access to a file from the operation panel 1408 of the own device.

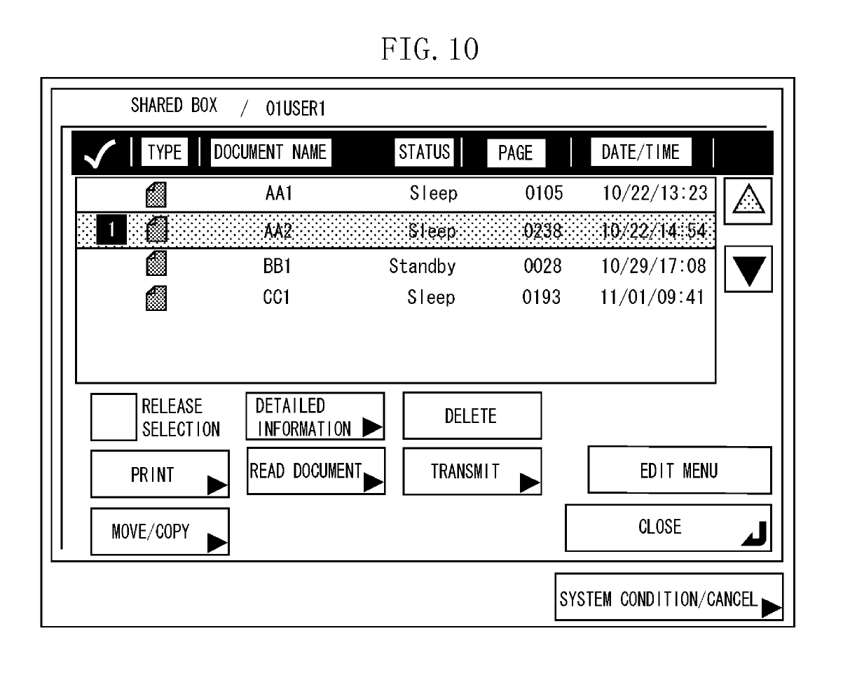

FIG. 10 illustrates an example of a display screen of the operation panel 1408 indicating a stored condition of a data file in a shared BOX.

In the exemplary embodiment, a file in the device B (102) is displayed, and the devices A (101) and C (103) have both transmitted file information to the device B (102) and are in sleep conditions.

In FIG. 10, data files “AA 1” and “AA 2” are actually stored in the device A (101), and a data file “BB 1” is actually stored in the own device (device B (102). A data file “CC 1” is actually stored in the device C (103).

The user can perform an access operation to the data files from the display screen of FIG. 10.

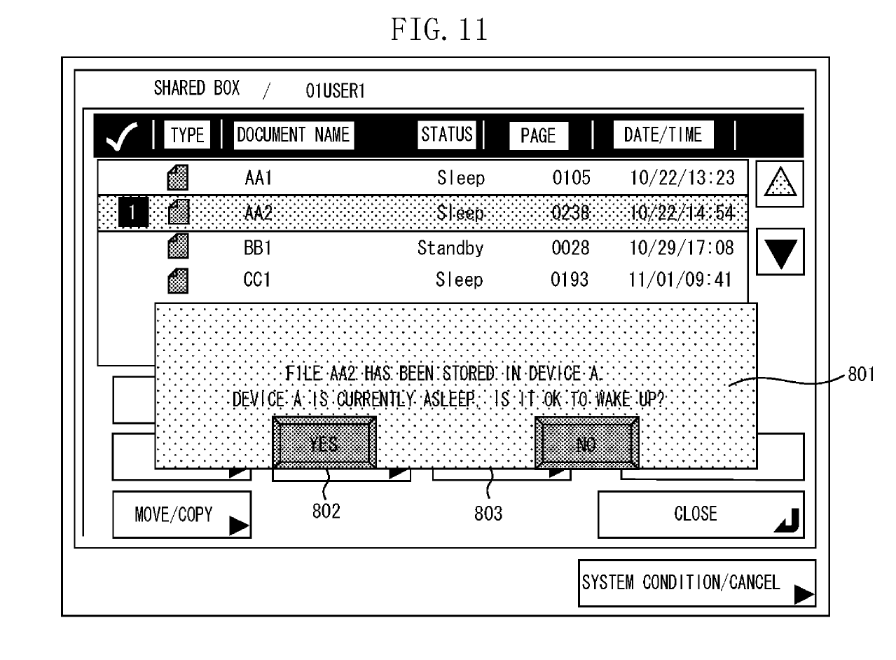

FIG. 11 illustrates an operation when a file having a filename “AA 2” stored in the device A in the sleep condition is selected among the files on the display screen of FIG. 10.

In this case, an operation of the file “AA 2” performs the waking-up of the device A from sleep, and hence the CPU of the control unit 1404 of the device B (102) displays a screen 801 (inquiry screen) to select whether it is permitted to wake up the device. The CPU of the control unit 1404 of the device B (102) carries out this display in response to reception of the notification of step S608 of FIG. 9B.

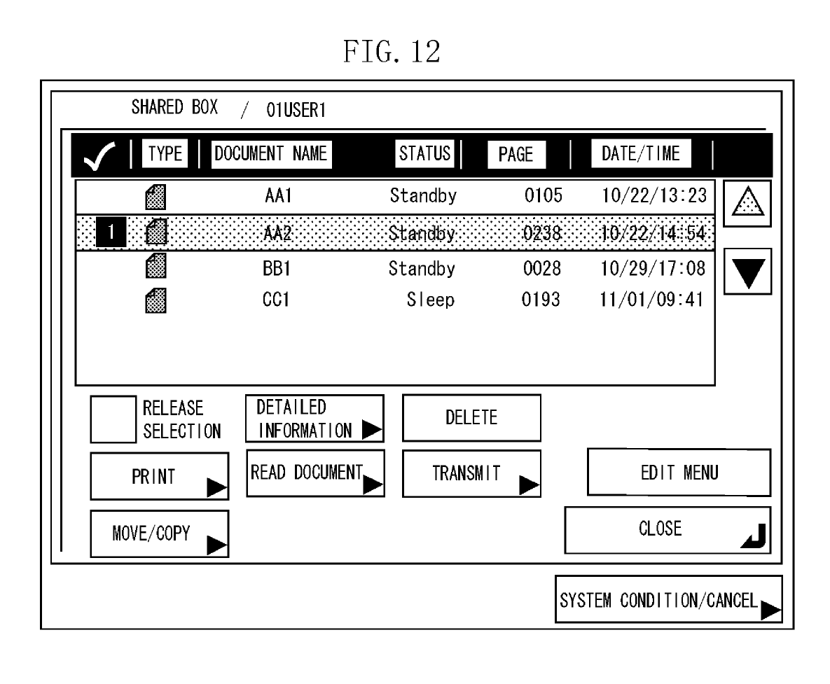

On the screen 801, when a “YES” button 802 is specified, the CPU of the control unit 1404 of the device B (102) gives an OK response (response indicating that it is permitted to wake up the device from sleep) to the transmission source of the notification of step S608 of FIG. 9B. Then, the CPU of the control unit 1404 displays a screen of FIG. 12 on the operation panel 1408.

On the other hand, when a “NO” button 803 is specified, the CPU of the control unit 1404 of the device B (102) gives an NG response (response indicating that it is not permitted to wake up the device from sleep) to the transmission source of the notification of step S608 of FIG. 9B.

FIG. 12 shows a screen of the operation panel when the “YES” button 802 is pressed on the screen 801 of FIG. 11 to wake up the device A from sleep. In this case, the devices A and B display identical screens.

As described above, according to the exemplary embodiment, by the method that allows free shifts of the individual digital multifunction peripherals to sleep conditions while realizing file sharing functions, power consumption can be reduced. Furthermore, when the last remaining device shifts to a sleep condition, the device consuming less standby power than the own device takes over, whereby a much better power saving condition can be maintained.

In the first exemplary embodiment, data of FIGS. 10 to 12 are displayed on the operation panel 1408. However, other than that, a method for displaying data on a remote UI by a driver configured to enable a remote operation from a personal computer (PC) or the like may be employed. This configuration will be described below as a second exemplary embodiment.

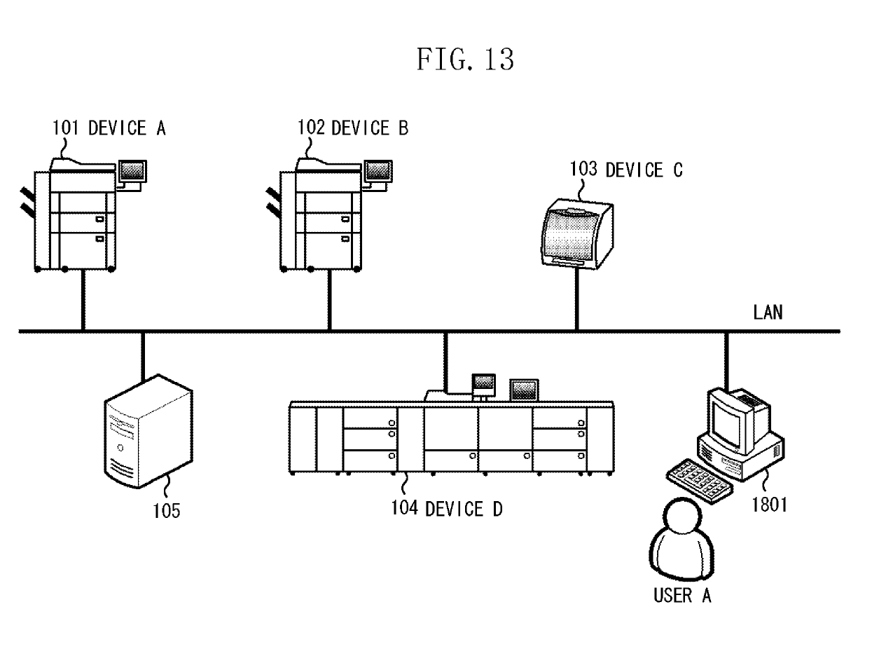

FIG. 13 is a configuration diagram illustrating an example of a configuration of a system including digital multifunction peripherals to which data storage devices according to the second exemplary embodiment of the present invention can be applied. Components identical to those of FIG. 1 have identical reference numerals.

In FIG. 13, a personal computer (PC) 1801 is added. In the exemplary embodiment, a user A can operate a file sharing function also from the PC 1801.

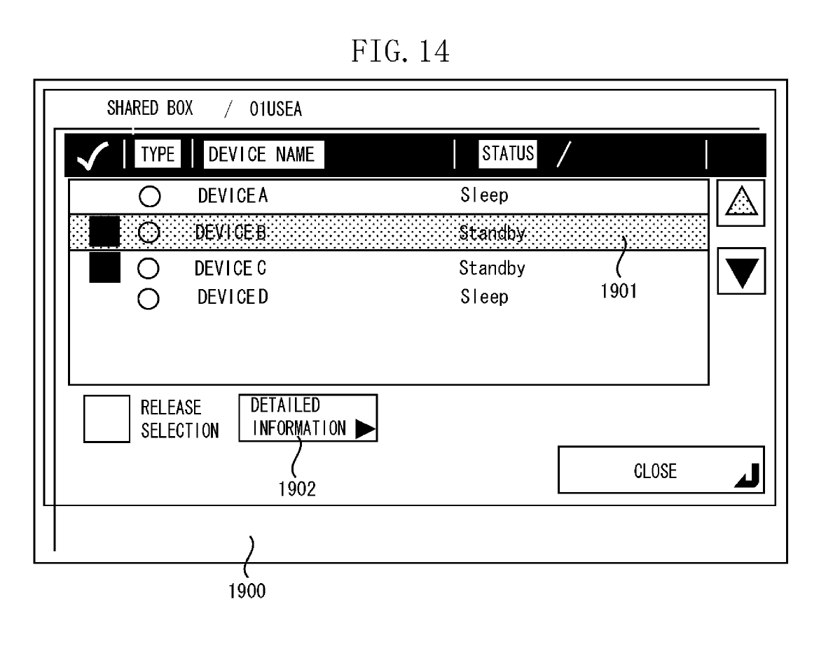

FIG. 14 illustrates an example of an operation screen 1900 when a shared BOX folder is opened by the file sharing function from the PC 1801 illustrated in FIG. 13.

When the shared BOX folder is opened by using the file sharing function from the PC 1801, first, the screen 1900 illustrated in FIG. 14 is displayed. A user can select a device about which it makes inquiry as indicated in 1901.

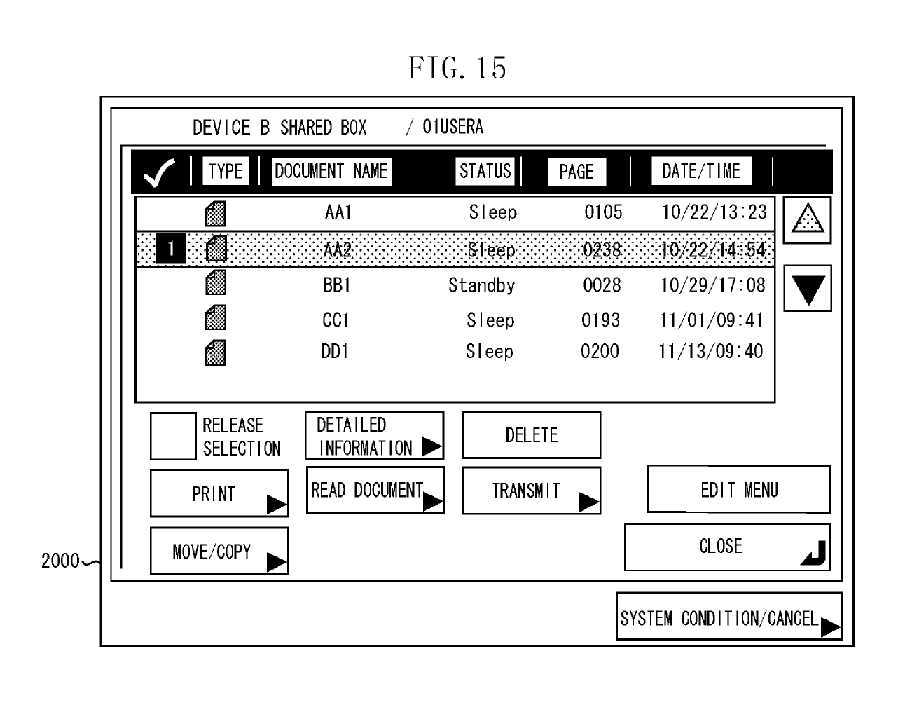

In the exemplary embodiment, an inquiry can be made only to a device on standby, and the user A can select the “device B” or the “device C” on standby. In the example illustrated in FIG. 14, as indicated in 1901, the “device B” is selected as a device to which an inquiry is made. In this condition, when a detailed information button 1902 is specified, a screen 2000 of FIG. 15 is displayed.

FIG. 15 illustrates an example of the selection screen 2000 displayed on the PC 1801 when the device B is selected.

As illustrated in FIG. 15, on the selection screen 2000, file information stored in the device B is displayed to be operable. File information of the other devices in sleep conditions which is stored in the device B also becomes operable.

As described above, according to the exemplary embodiment, the user can browse file information stored in the shared BOX folder from the PC 1801 by using the file sharing function, and hence a power saving condition can be maintained without carelessly releasing a sleep condition of the digital multifunction peripheral. For example, because of use of the file sharing function, irrespective of presence of other woken-up digital multifunction peripherals, the user may wake up a digital multifunction peripheral in a sleep condition located near user's seat, consequently wasting power. This situation can be prevented.

The first exemplary embodiment has been described by way of the configuration where each digital multifunction peripheral transmits file information in the shared BOX folder of its own device to the other device before entering a sleep condition. However, a configuration may be employed, in which when the digital multifunction peripherals are connected to the network and woken up, the digital multifunction peripherals transfer file information in the shared BOX folders with each other. This configuration will be described below as a third exemplary embodiment.

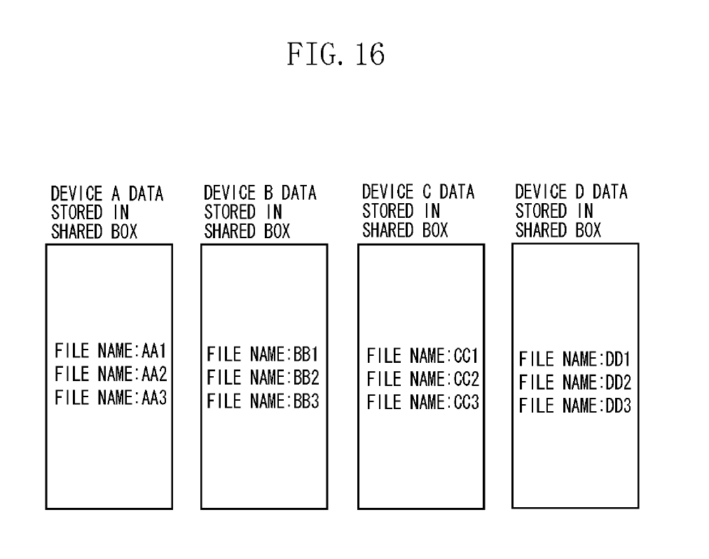

FIG. 16 is a conceptual diagram illustrating data stored in a shared BOX folder by each digital multifunction peripheral according to the third exemplary embodiment of the present invention.

In the present exemplary embodiment, when the digital multifunction peripherals are connected to the network, the digital multifunction peripherals transfer file information in the shared BOX folders with each other.

In this case, the file information (identification information) may contain instead of the substantive file additional information such as a file name or network pass information to specify a storage destination of the substantive file, and additionally a part of file information of a relatively small capacity such as a thumbnail image.

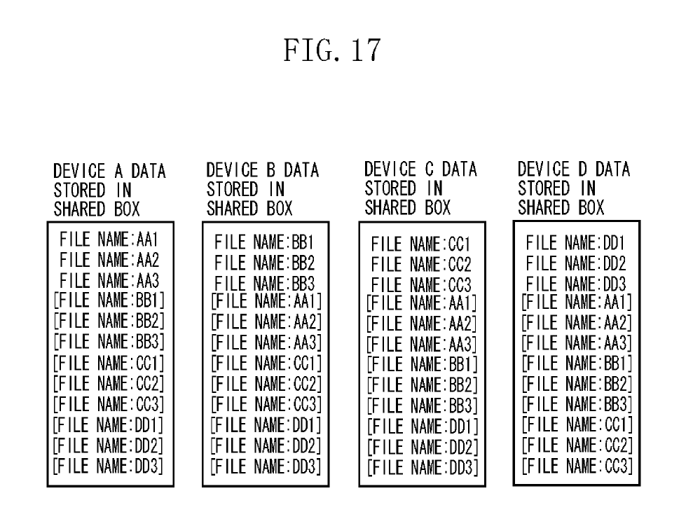

FIG. 17 illustrates a condition in which as a result of transferring the file information in the shared BOX folders between the devices from the condition of FIG. 16, each device stores the file information of the other device in its shared BOX folder.

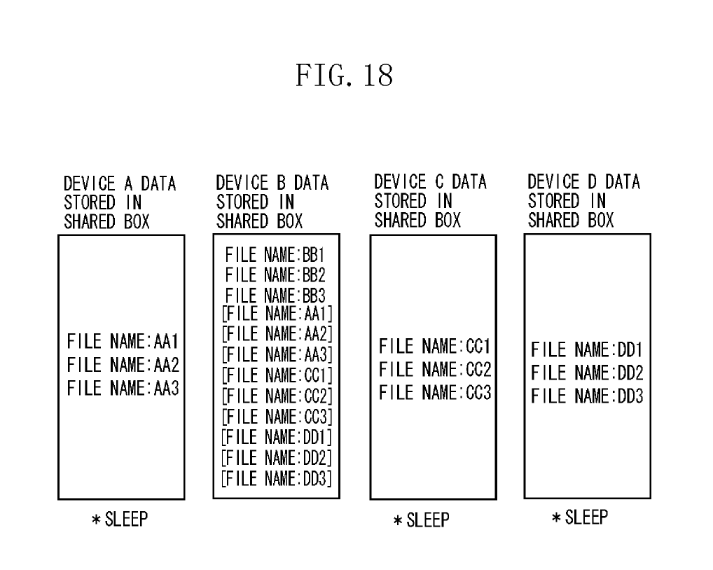

FIG. 18 illustrates a condition in which devices A, C and D have entered sleep conditions from the condition of FIG. 17, and only a device B stores all file information on behalf of the other devices.

When the devices A, C and D enter the sleep conditions, each device deletes file information of the other devices stored therein.

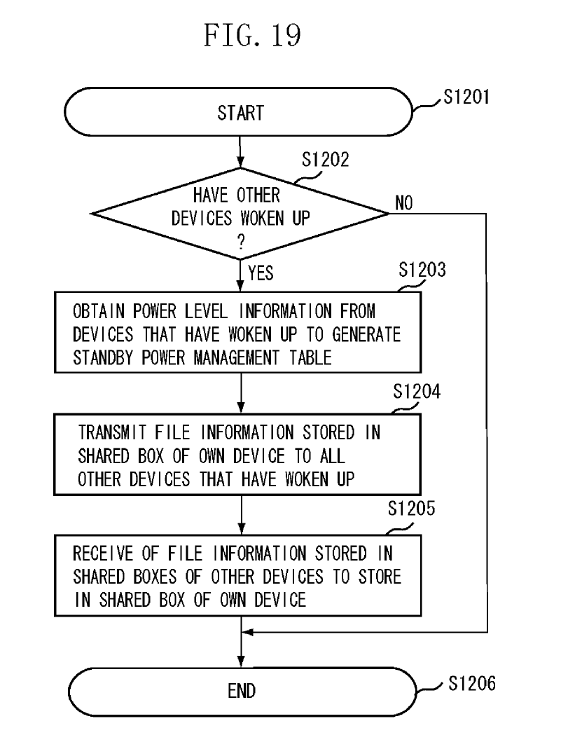

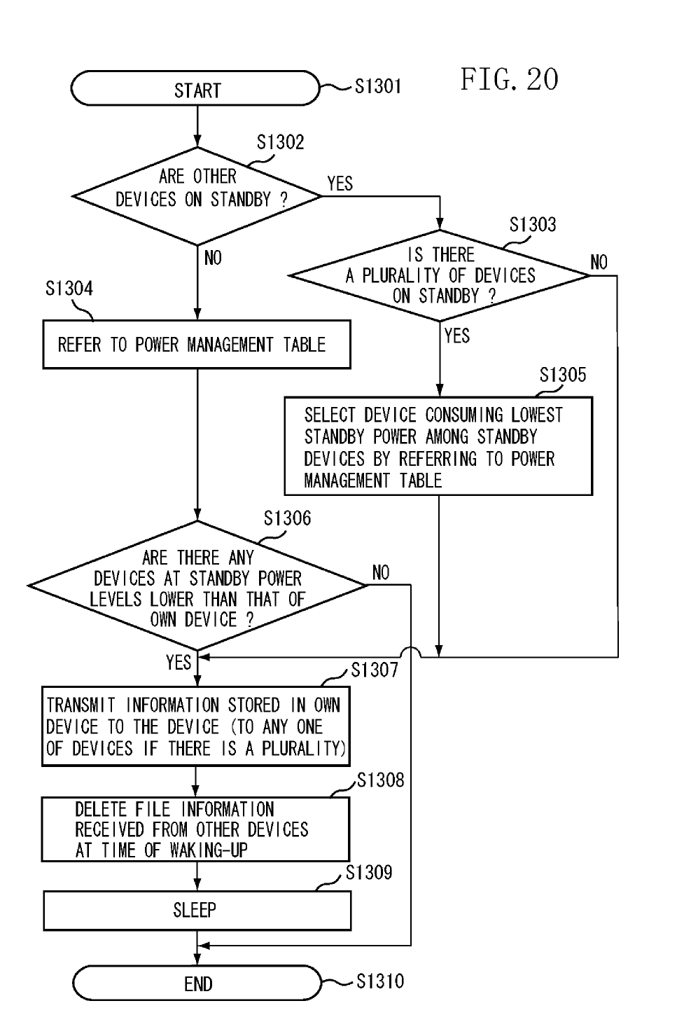

Referring to FIGS. 19 and 20, processing of the digital multifunction peripheral of the third exemplary embodiment of the present invention will be described below.

FIG. 19 is a flowchart illustrating an example of processing when the digital multifunction peripheral of the exemplary embodiment wakes up to transmit file information to the other devices connected to the network. The processing of the flowchart is realized when a CPU of a control unit 1404 executes a program stored in a ROM of the control unit 1404.

In step S1201, when the digital multifunction peripheral wakes up and its connection to the network is detected, the CPU of the control unit 1404 starts the processing of the flowchart.

Instep S1202, the CPU of the control unit 1404 checks whether the other devices having file sharing functions and connected to the network have woken up. If it is determined that the other devices have not woken up (NO in step S1202), in step S1206, the CPU of the control unit 1404 finishes the processing of the flowchart.

On the other hand, if it is determined that the other devices have woken up (YES in step S1202), the CPU of the control unit 1404 proceeds to step S1203.

In step S1203, the CPU of the control unit 1404 obtains power level information from all the other devices having file sharing functions which have woken up to generate a standby power management table.

Next, in step S1204, the CPU of the control unit 1404 transmits file information stored in the shared BOX folder of the own device to the other devices that have woken up (wake-up time transmission processing).

In step S1205, the CPU of the control unit 1404 communicates (makes a request to) with the other devices that have woken up and receives file information transmitted from the other devices (wake-up time reception processing). Then, in step S1206, the CPU of the control unit 1404 finishes the processing of the flowchart.

There is no preference in order between step S1204 and step S1205. The file information to be transmitted and received includes as additional information partial information containing a file name of a file stored in the shared BOX folder, network pass information, or information such as an IP address to specify a storage place.

Referring to FIG. 20, processing when the digital multifunction peripheral of the exemplary embodiment enters a sleep condition will be described below.

FIG. 20 is a flowchart illustrating processing when the digital multifunction peripheral of the exemplary embodiment enters the sleep condition. The processing of the flowchart is realized when the CPU of the control unit 1404 reads a program stored in the ROM of the control unit 1404 and executes the program.

First, in step S1301, the CPU of the control unit 1404 executes monitoring to determine whether sleep conditions have been satisfied. Upon determining that the sleep conditions have been satisfied, the CPU of the control unit 1404 starts the processing of the flowchart.

In step S1302, the CPU of the control unit 1404 determines whether other devices connected within the same network are on standby. If it is determined that the other devices are on standby (YES in step S1302), the CPU of the control unit 1404 proceeds to step S1303.

In step S1303, the CPU of the control unit 1404 determines whether there is a plurality of devices on standby. If it is determined that there is a plurality of devices on standby (YES in step S1303), the CPU of the control unit 1404 proceeds to step S1305.

In step S1305, the CPU of the control unit 1404 selects a device consuming lowest standby power among the standby devices by referring to a power management table of FIG. 6 stored in the data storage unit 1405. Then, the CPU of the control unit 1404 proceeds to step S1307.

On the other hand, if it is determined that there is only one device on standby (NO in step S1303), the CPU of the control unit 1404 selects the device and proceeds to step S1307.

If it is determined that no other devices are on standby, in other words, there is only one device having a file sharing function, i.e., an own device, in the same network group (NO in step S1302), the CPU of the controlling unit 1404 proceeds to step S1304.

In step S1304, the CPU of the control unit 1404 refers to the power management table of FIG. 6 stored in the data storage unit 1405 and proceeds to step S1306.

In step S1306, based on the power management table of FIG. 6, the CPU of the control unit 1404 determines whether there are any devices in sleep conditions at standby power consumption levels lower than that of the own device. If it is determined that there are devices in sleep conditions at standby power consumption levels lower than that of the own device (YES in step S1306), the CPU of the control unit 1404 selects the devices and proceeds to step S1307.

In step S1307, the CPU of the control unit 1404 transmits information stored in the own device to the selected devices. If it is determined in step S1306 that there is a plurality of devices in sleep conditions at standby power consumption levels lower than that of the own device, the CPU of the control unit 1404 determines which of the devices at the standby power consumption levels lower than that of the own device is to wake up according to a predetermined determination order. For example, the CPU of the control unit 1404 makes determination based on a priority such as a high usage frequency or a large free capacity of the shared file storage units 1406.

If it is determined in step S1305 that there is a plurality of standby devices consuming lowest standby power, the CPU of the control unit 1404 determines which of the devices is to wake up according to a predetermined determination order.

The information stored in the own device and transmitted in step S1307 indicates only file information having a substantive data file stored in the own device. In other words, no file information (file information collected from the other devices) having substantive data files stored in the other devices is included.

Next, in step S1308, the CPU of the control unit 1404 deletes the file information collected from the other devices and proceeds to step S1309.

Instep S1309, the CPU of the control unit 1404 shifts to a sleep condition. In step S1310, the CPU of the control unit 1404 finishes the processing of the flowchart.

On the other hand, if it is determined that there is no device in a sleep condition at a standby power consumption level lower than that of the own device (NO in step S1306), in step S1310, the CPU of the control unit 1404 finishes the processing of the flowchart without shifting to a sleep condition.

In the exemplary embodiment, in step S1305, the CPU of the control unit 1404 determines devices to which file information is transmitted according to a standby power consumption level in the power management table starting from the smallest level. However, a method for determining a file information transmission destination is not limited to this method. For example, a configuration may be employed that determines devices to which data information is transmitted based on other criteria preset and managed in the power management table such as access frequencies and large free capacities of the shared BOX folders.

In step S1305, all the devices on standby may be selected as devices to which file information is transmitted.

As described above, according to the present exemplary embodiment, by the method that allows free shifts of the individual digital multifunction peripherals to sleep conditions while realizing file sharing functions power consumption can be reduced. Furthermore, when the last remaining device shifts to a sleep condition, the device consuming less standby power than the own device takes over, whereby a much better power saving condition can be maintained.

In addition, a configuration may be employed, in which the PC server 105 stores the power management table illustrated in FIG. 6 to manage s standby power consumption level of each device. In this case, each digital multifunction peripheral obtains the power management table from the PC server 105, and determines a standby power consumption level of each device based on the obtained power management table. Each digital multifunction peripheral may notify the PC server 105 of a standby power consumption level of the own device when a device configuration is changed or during waking-up.

The PC server 105 may be in overall control of conditions of the digital multifunction peripherals. For example, before entering a sleep condition, each digital multifunction peripheral inquires the PC server 105 whether it is permitted to shift to the sleep condition. If there are devices at standby power consumption levels lower than that of the inquired device and the devices are in woken-up conditions, based on the power management table which the PC server 105 holds, the PC server 105 permits the inquired device to shift to a sleep condition. If there are devices at standby power consumption levels lower than that of the inquired device, and the devices are in sleep conditions, the PC server 105 permits the inquired device to shift to a sleep condition, and wakes up the device consuming lowest standby power from the sleep condition.

The digital multifunction peripheral permitted to shift to the sleep condition transmits file information stored in the shared BOX folder of the own device to the PC server 105 to shift to the sleep condition. Then, the PC server 105 that has received the file information transmits the received file information to the devices at standby power consumption levels lower than that of the device which has shifted to the sleep condition.

The above-described configurations of various data and contents thereof are in no way limitative. According to usages and purposes, various configurations and contents can be employed. The above described is the exemplary embodiments of the present invention. The present invention can be embodied into a system, an apparatus, a method, a program or a storage medium. More specifically, the invention may be applied to a system which includes a plurality of devices, or an apparatus which includes one device.

As described above, when each device constituting the shared file system connected to the network shifts to the sleep condition, the device notifies the other devices of identification information (partial information such as a file name) of the data file stored in the own device to shift to the sleep condition. When the last remaining device shifts to the sleep condition, the device wakes up the other devices consuming less standby power from sleep, and then notifies the other devices of identification information of the data file stored in the own device to shift to the sleep condition.

Thus, the file sharing function is effectively utilized to permit the unnecessary device to shift to a power saving condition, and when the last remaining device shifts to a power saving condition, the device consuming less standby power takes over. As a result, the power saving condition can be maintained for the entire system.

Thus, in the system including the data storage devices which have file sharing functions to enable mutual reference to the data among the data storage devices connected to the network, an optimal power saving system that suppresses wasteful power consumption while maintaining file sharing functions can be constructed.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2008-335391 filed Dec. 27, 2008, which is hereby incorporated by reference herein in its entirety.

What is claimed is:

1. A data storage device comprising:
a first storage unit configured to store data;
a reception unit configured to receive a request of access to the stored data from an external device;
a transmission unit configured to transmit, to the external device, data corresponding to the access request;
a control unit configured to perform, when shifting from a standby condition to a power saving condition, control so that identification information for identifying the stored data is transmitted to other data storage devices in the standby condition; and
wherein when there are no other data storage devices in the standby condition, the control unit specifies one of the other data storage devices, an amount of power consumption of which is lower than that of the data storage device by referring to the stored standby power information, causes the specified data storage device to shift from the power saving condition to the standby condition and transmits the identification information to the specified data storage device in the standby condition.

2. The device according to 1, further comprising a second storage unit configured to store the standby power information indicating power consumption of the other data storage devices in the standby condition.

3. The device according to claim 1, wherein when there are neither other data storage devices in the standby condition nor other data storage devices, an amount of power consumption of which is lower than that of the data storage device, the control unit inhibits a shift from the standby mode to the power saving condition.

4. The device according to claim 1, wherein when there is a plurality of other data storage devices in the standby condition, the control unit transmits the identification information to a data storage device, an amount of power consumption of which is a lowest among the plurality of other data storage devices in the standby condition.

5. The device according to claim 1, further comprising a collection unit configured to collect the standby power information from the other data storage devices and to store the information in one of the first and second storage units.

6. The device according to claim 1, wherein the identification information of the data is partial information which does not includes substantive data.

7. The device according to claim 6, wherein the identification information includes information indicating a file name of the data and a storage destination of the data.

8. The device according to claim 1, further comprising a reception unit configured to receive the identification information transmitted from the other data storage devices and to store the identification information in one of the first and second storage units,
wherein the reception unit receives access to data indicating substantive identification information based on the stored identification information.

9. The device according to claim 8, wherein the reception unit includes:
an inquiry unit configured to inquire, when access to the data indicating the substantive identification information stored in the storage unit is received, an access source whether to wake up the other data storage device which stores the data indicating the substantive identification information,
wherein the control unit causes the other data storage device to shift from the power saving condition to the standby condition when a result of the inquiry by the inquiry unit is a response indicating waking-up of the other data storage device.

10. The data storage device according to claim 1, further comprising:
a wake-up time transmission unit configured to transmit, when the power saving condition of the data storage device is shifted to the standby condition, the identification information of the stored data stored to the other data storage devices; and
a wake-up time reception unit configured to receive, when the power saving condition of the data storage device is shifted to the standby condition, the identification information of the stored data from the other data storage devices, and to store the identification information in the storage unit.

11. A method for controlling a data storage device including a storage unit configured to store data, a reception unit configured to receive a request of access to the stored data stored from an external device, a transmission unit configured to transmit, to the external device, data corresponding to the access request,
the method comprising:
performing, when shifting from a standby condition to a power saving condition, control so that identification information of the stored data is transmitted to other data storage devices in the standby condition; and
when there are no other data storage devices in the standby conditions in the network, specifying one of the other data storage devices, an amount of power consumption of which is lower than that of the data storage device by referring to the stored standby power information, causing the specified data storage device to shift from the power saving condition to the standby condition and transmitting the identification information to the specified data storage device in the standby condition.

12. The method according to claim 11, wherein when there are neither other data storage devices in the standby condition nor other data storage devices, an amount of power consumption of which is lower than that of the data storage device, the control unit inhibits a shift from the standby mode to the power saving condition.

13. The method according to claim 11, wherein when there is a plurality of other data storage devices in the standby condition, the control unit transmits the identification information to a data storage device, an amount of power consumption of which is a lowest among the plurality of other data storage devices in the standby condition.

14. The method according to claim 11, further comprising collecting the standby power information from the other data storage devices and storing the information in the storage unit.

15. The method according to claim 11, wherein the identification information of the data is partial information which does not include substantive data.

16. The method according to claim 15, wherein the identification information includes information indicating a file name of the data and a storage destination of the data.

17. The method according to claim 11, further comprising:
receiving the identification information transmitted from the other data storage devices and storing the identification information in the storage unit by a reception unit,
wherein the reception unit receives access to data indicating the substantive identification information based on the stored identification information.

18. The method according to claim 17, wherein the reception includes:
inquiring, when access to the data indicating the stored substantive identification information is received, an access source whether to wake up the other data storage device which stores the data indicating the substantive identification information; and
shifting the other data storage device from the power saving condition to the standby condition when a result of the inquiry by the inquiry unit is a response indicating waking-up of the other data storage device.

19. The method according to claim 11, further comprising:
transmitting, when the power saving condition of the data storage device is shifted to the standby condition, the identification information of the stored data stored to the other data storage devices; and
receiving, when the power saving condition of the data storage device is shifted to the standby condition, the identification information of the stored data stored from the other data storage devices, and storing the identification information in the storage unit.

20. A computer-readable recording medium recording a program for causing a computer to execute the method for controlling the data storage device specified in claim 11.
